(19) United States
(12) Patent Application Publication
(10) Pub. No.: US 2018/0359970 A1
(43) Pub. Date: Dec. 20, 2018

(54) BED SEED HOLDERS AND ASSEMBLY LINE GROW PODS HAVING BED SEED HOLDERS

(71) Applicant: Grow Solutions Tech LLC, Lehi, UT (US)

(72) Inventors: Gary Bret Millar, Highland, UT (US); Mark Gerald Stott, Eagle Mountain, UT (US); Todd Garrett Tueller, American Fork, UT (US); Michael Stephen Hurst, Farmington, UT (US); Alan Ray Bentley, Alpine, UT (US); Taylor John Woodbury, Provo, UT (US)

(73) Assignee: Grow Solutions Tech LLC, Lehi, UT (US)

(21) Appl. No.: 15/986,128

(22) Filed: May 22, 2018

Related U.S. Application Data
(60) Provisional application No. 62/519,310, filed on Jun. 14, 2017.

(51) Int. Cl. A01G 27/00; A01G 31/06; A01G 9/029

(52) U.S. Cl. CPC A01G 27/003; A01G 27/008; A01G 9/029; A01G 31/06

(57) ABSTRACT

Disclosed herein are bed seed holders and assembly line grow pods incorporating bed seed holders for growing plants. According to some embodiments, a bed seed holder includes a body having an elevation envelope, at least one seed receptacle extending into the body, where the seed receptacle is adapted to maintain a fluid within the seed receptacle, and a spigot that is adapted to maintain a level of the fluid within the body below the elevation envelope.

### RELATED APPLICATIONS

This application claims the benefit of U.S. provisional application No. 62/519,310, filed on Jun. 14, 2017, which is hereby incorporated by reference in its entirety.

### FIELD

Embodiments described herein generally relate to systems and methods directed to growing plants in a bed seed holder and, more specifically, to a bed seed holder for an assembly line grow pod.

### BACKGROUND

While crop growth technologies have advanced over the years, there are still many problems in the farming and crop industry today. As an example, while technological advances have increased efficiency and production of various crops, many factors may affect a harvest, such as weather, disease, infestation, and the like. Additionally, while the United States currently has suitable farmland to adequately provide food for the U.S. population, other countries and future populations may not have enough farmland to provide the appropriate amount of food.

Additionally, while many current greenhouses utilize a controlled environment, these embodiments typically utilize trough-like planters with soil to grow pants. As these current solutions not only introduce undesirable chemicals, pesticides, and the like, the efficiency of growth is typically compromised. As such, a need exists in the industry.

### SUMMARY

Disclosed herein are bed seed holders and assembly line grow pods incorporating bed seed holders for growing plants. The bed seed holders and the assembly line grow pods may allow for growing plants in a highly-monitored manner, such that conditions of the seed or plant positioned within the bed seed holder can be monitored and conditions can be adjusted based on pre-determined conditions.

According to some embodiments, a bed seed holder includes a body having an elevation envelope, at least one seed receptacle extending into the body, where the seed receptacle is adapted to maintain a fluid within the seed receptacle, and a spigot that is adapted to maintain a level of the fluid within the body below the elevation envelope.

According to some embodiments, an assembly line grow pod includes a track, a plurality of industrial carts adapted to translate along the track, and at least one bed seed holder positioned on the industrial carts. Each of the bed seed holders includes a body and at least one seed receptacle extending into the body, where the seed receptacle is adapted to maintain a fluid within the seed receptacle. The assembly line grow pod also includes a watering component that evaluates the water level within the at least one seed receptacle and selectively controls distribution of water to and from the bed seed holders to maintain to a pre-determined level.

According to some embodiments, a method of growing a plant from a seed includes delivering seed to at least one seed receptacle of a bed seed holder using a seeder component and distributing water to the bed seed holder. The method also includes evaluating a level of water in the at least one seed receptacle with a water level sensor, and distributing additional water to the bed seed holder to increase the level of water to a predetermined level.

It is to be understood that both the foregoing general description and the following detailed description are merely exemplary, and are intended to provide an overview or framework to understanding the nature and character of the claimed subject matter. The accompanying drawings are included to provide a further understanding and are incorporated in and constitute a part of this specification. The drawings illustrate one or more embodiment(s), and together with the description, serve to explain principles and operation of the various embodiments.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 is a side perspective view of an assembly line grow pod for providing a bed seed holder, according to embodiments described herein;

FIG. 2 is a side view an industrial cart that may house a bed seed holder, according to embodiments described herein;

FIG. 3A is a side perspective view of a bed seed holder according to embodiments described herein;

FIG. 3B is a side schematic view of a bed seed holder according to embodiments described herein;

FIG. 3C is a side schematic view of a bed seed holder according to embodiments described herein;

FIG. 3D is a side schematic view of a bed seed holder according to embodiments described herein;

FIG. 4 depicts a bed seed holder with a trapezoidal shape according to embodiments described herein; and

FIG. 5 depicts a side view of a bed seed holder with a flange and a spigot, according to embodiments described herein;

FIG. 6 depicts a flowchart for providing a bed seed holder, according to embodiments described herein;

FIG. 7 depicts a computing environment for providing a bed seed holder, according to embodiments described herein; and

FIG. 8 depicts a computing device for providing a bed seed holder, according to embodiments described herein.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

Numerical values, including endpoints of ranges, can be expressed herein as approximations preceded by the term “about,” “approximately,” or the like. In such cases, other embodiments include the particular numerical values. Regardless of whether a numerical value is expressed as an approximation, two embodiments are included in this disclosure: one expressed as an approximation, and another not expressed as an approximation. It will be further understood that an endpoint of each range is significant both in relation to another endpoint, and independently of another endpoint.

Directional terms as used herein—for example up, down, right, left, front, back, top, bottom—are made only with reference to the figures as drawn and are not intended to imply absolute orientation.

As will be discussed in greater detail below, embodiments disclosed herein include a bed seed holder and methods of processing seeds using a bed seed holder. Some embodiments are configured with a static bed seed holder with a plurality of cells for receiving one or more seeds. In the context of an assembly line grow pod, these individual cells may then be monitored for growth of the plant from deposit to harvest. Additionally, some embodiments of the bed seed holder have a flange and a spigot. In these embodiments, the bed seed holder may receive and maintain a predetermined volume of water (and/or nutrients) such that the seeds are submerged in the water. The flange allows water to pool, thereby submerging the seeds. The spigot may be positioned to prevent water from pooling to a depth that is greater than a predetermined depth and is positioned such that overflow is directed to a waste receiving reservoir, such as on a track. The bed seed holder and methods of using the bed seed holder will be described in more detail below.

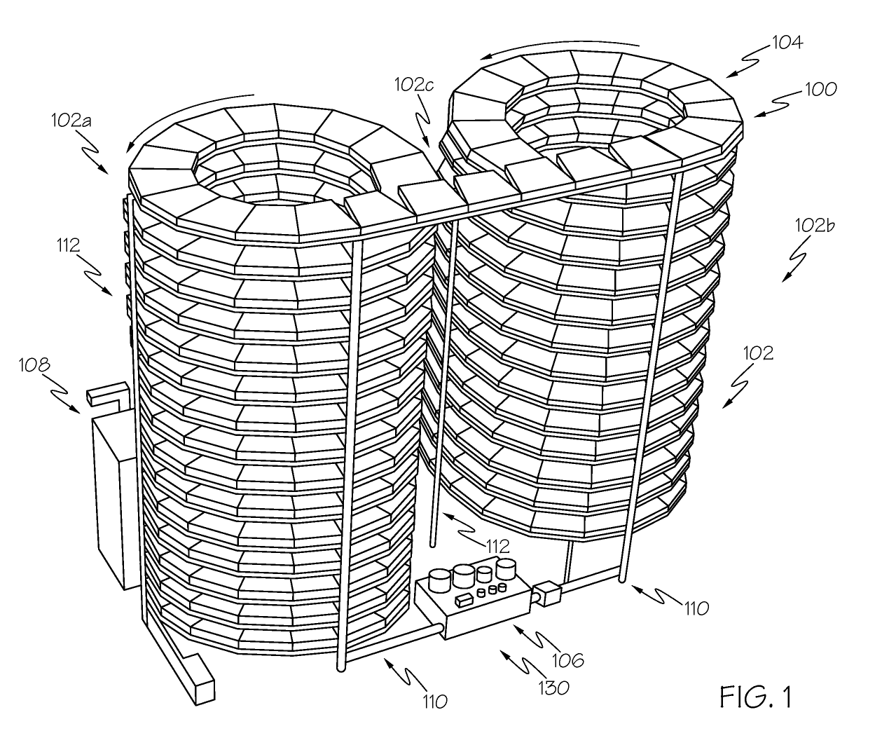

Referring now to the drawings, FIG. 1 depicts an assembly line grow pod 100 for providing a bed seed holder, according to embodiments described herein. As illustrated, the assembly line grow pod 100 may include a track 102 that holds one or more industrial carts 104. The track 102 may include an ascending portion 102a, a descending portion 102b, and a connection portion 102c. The track 102 may be formed in a spiral shape around a first axis (in a counterclockwise direction looking down in FIG. 1) such that the industrial carts 104 ascend upward in a vertical direction. In some embodiments, the connection portion 102c may be relatively level (although this is not a requirement). Industrial carts 104 may be transferred from the ascending portion 102a across the connection portion 102c to the descending portion 102b. The descending portion 102b may be formed in a spiral shape around a second axis (again in a counterclockwise direction looking down in FIG. 1) that is substantially parallel to the first axis, such that the industrial carts 104 may be returned closer to ground level.

While not explicitly illustrated in FIG. 1, the assembly line grow pod 100 may also include a plurality of lighting devices, such as light emitting diodes (LEDs). The lighting devices may be disposed on the track 102 below the location of circulation of the industrial carts 104, such that the lighting devices direct light to the industrial carts 104 on the portion the track 102 directly below where the lighting devices are positioned. In some embodiments, the lighting devices are configured to create a plurality of different colors and/or wavelengths of light, depending on the application, the type of plant being grown, and/or other factors. While in some embodiments, LEDs are utilized for this purpose, this is not a requirement. Any lighting device that produces desired functionality may be utilized. Lights having high efficiency and low heat generation may be desired to reduce the operating costs of the assembly line grow pod 100.

Also depicted in FIG. 1 is a master controller 106. The master controller 106 may include a computing device 130, a nutrient dosing component, a water distribution component, and/or other hardware for controlling various components of the assembly line grow pod 100. Coupled to the master controller 106 is a seeder component 108. The seeder component 108 may be configured to deliver seed to one or more industrial carts 104 as the industrial carts 104 pass the seeder as the industrial carts 104 circulate along the track 102. According to various embodiments, the industrial carts 104 may include a variety of designs to accommodate the specifications of a particular operation. In some embodiments, each industrial cart 104 may include a single section tray for receiving a plurality of seeds. In some embodiments, each industrial cart 104 may include a multiple section (or “cell”) tray for receiving individual seeds in each section. In the embodiments with a single section tray, the seeder component 108 may detect presence of the respective industrial cart 104 and may lay seed across an area of the single section tray. The seed may be laid out according to a desired depth of seed, a desired number of seeds, a desired surface area of seeds, and/or other criteria. In some embodiments, the seeds may be pre-treated with nutrients and/or anti-buoyancy agents (such as water) as these embodiments may not utilize soil to grow the seeds and thus may be submerged.

In the embodiments where a multiple section tray is utilized with one or more of the industrial carts 104, the seeder component 108 may be configured to insert seeds into one or more of the sections of the tray. Again, the seeds may be distributed on the tray (or into individual cells) according to a desired number of seeds, a desired area the seeds should cover, a desired depth of seeds, and the like.

The assembly line grow pod 100 may include a watering component 109 that may be coupled to one or more water lines 110, which distribute water and/or nutrients to one or more trays at predetermined areas of the assembly line grow pod 100. In some embodiments, seeds may be sprayed to reduce buoyancy and then the tray may be flooded. Additionally, water usage and consumption may be monitored, such that at subsequent watering stations, water usage and consumption data may be utilized to determine an amount of water to apply to a seed at that time.

The assembly line grow pod 100 may also include airflow lines 112. The master controller 106 may include and/or be coupled to one or more control components that delivers airflow to the assembly line grow pod 100 from the airflow lines 112 for temperature control, pressure, carbon dioxide control, oxygen control, nitrogen control, and the like. Accordingly, the airflow lines 112 may distribute the airflow at predetermined areas in the assembly line grow pod 100.

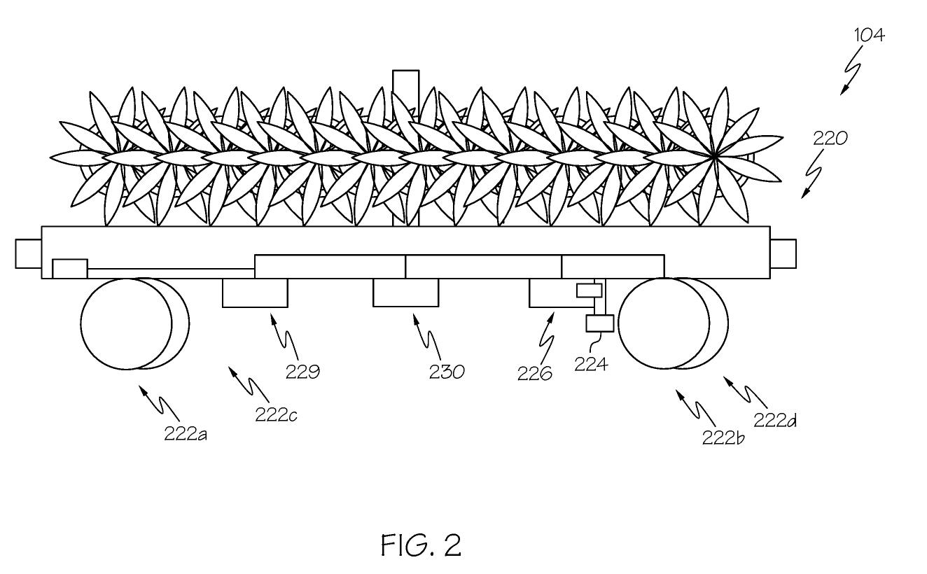

FIG. 2 depicts an industrial cart 104 that may house a bed seed holder 230, according to embodiments described herein. As illustrated, the industrial cart 104 may include a tray 220, which may be rotatable for disposing plants during harvest and/or for cleaning. As part of the tray 220, the bed seed holder 230 may be disposed on the cart and may include a plurality of cells for receiving one or more seeds. In some embodiments, the bed seed holder 230 may include a planting medium, for example soil. In some embodiments, the seed may be positioned within the bed seed holder 230 without a planting medium. The industrial cart 104 may additionally include a cart computing device 232 for communicating with the assembly line grow pod 100.

As an example, some embodiments of the bed seed holder 230 may be configured as a static component. However, some embodiments may be configured such that the bed seed holder 230 may receive and execute commands from the master controller 106 and/or from the cart computing device. As an example, the spigot may be movable, such that water may be stored or evacuated upon command. Similarly, some embodiments may be configured such that one or more of the cells are configured for opening and/or closing to allow disposal of water and/or seeds.

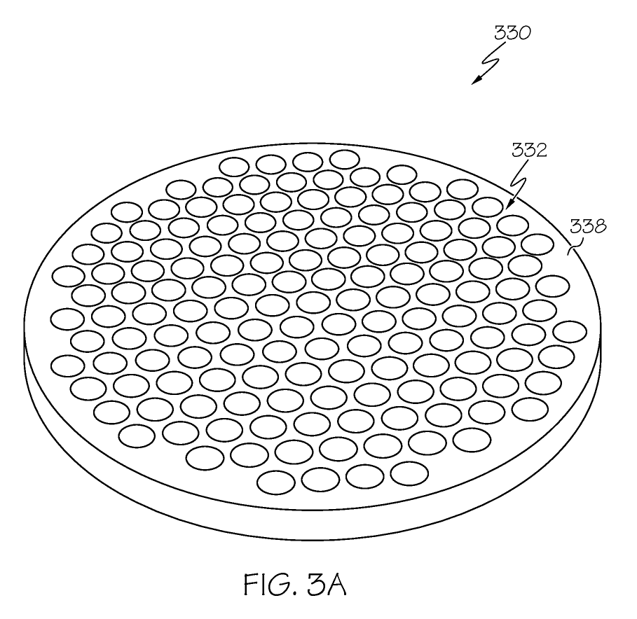

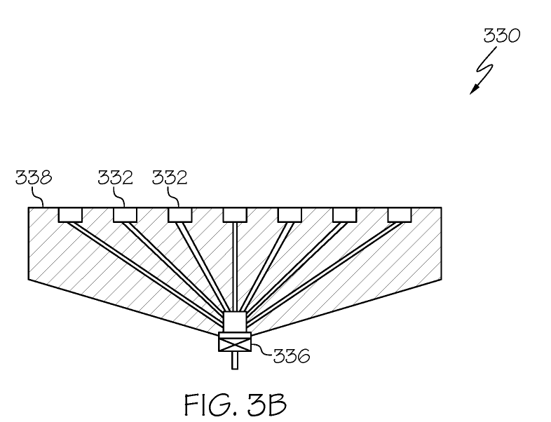

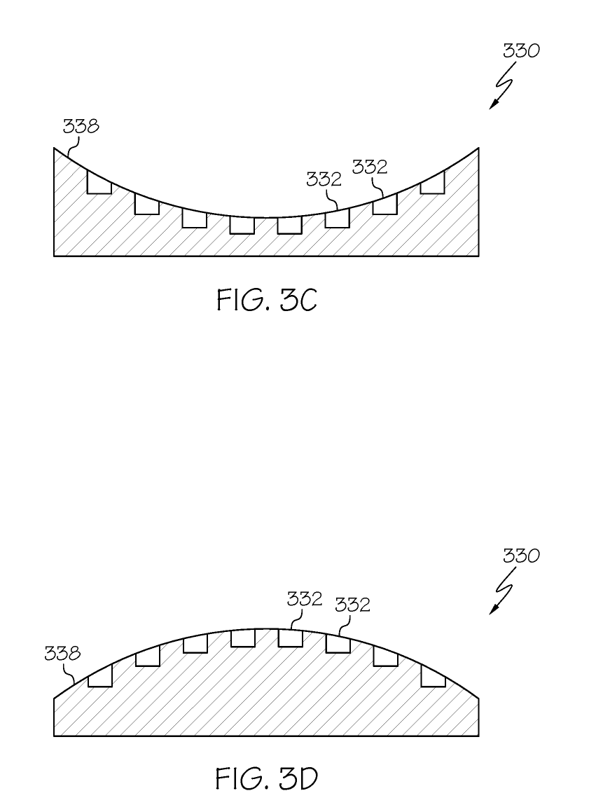

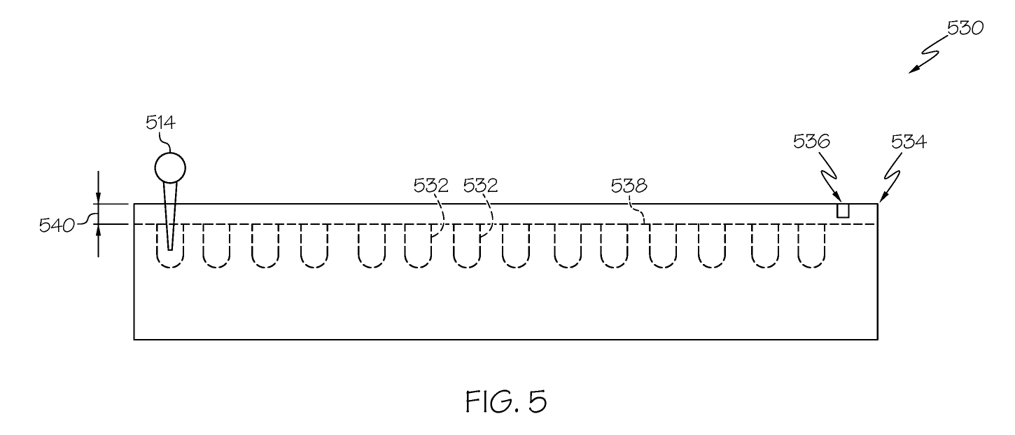

FIGS. 3A-3D depict bed seed holders 330 with a generally round overall shape, according to some embodiments described herein. The bed seed holder 330 includes a plurality of cells 332 that extend a distance from a crown surface 338 of the bed seed holder 330. The shape of the bed seed holder 330 may be determined based on a shape of the industrial cart 104, a shape of the tray 220 (as shown in FIG. 2), the type of plant, and/or on other factors. Additionally, the bed seed holder 330 may include a flange (as illustrated in FIG. 5) that extends around a perimeter of the bed seed holder 330 to allow water to pool above the crown surface 338.

It should be understood that the cells 332 are depicted as having a rounded cross section, the particular shape of the cells does not limit the scope of the embodiments described herein. In some embodiments, the cells 332 may have a circular cross section, a rectangular cross section, a triangular cross section, and the like. The shape of the cells 332 may be selected based on the type of seed (or types of seeds) being grown. Similarly, the three dimensional shape of the cells 332 may be spherical, rectangular, cylindrical, and/or other shape as selected to grow the desired plant. The spacing and number of cells 332 may also depend on the type plant being grown and/or other factors.

The shape, size, and configuration of the cells 332 in the bed seed holder 330 may be selected to encourage desired growth properties of the seed that is positioned within the cells 332. For example, in some examples, the seed in the cells 332 will grow into plants having root mass that uptakes water and nutrients. For some plant types, at least portions of the root mass will grow out of the cell 332 and intertwine with roots of other plants in the bed seed holder 330. By selecting particular shapes, sizes, and configurations of the cells 332, the growth characteristics of the plant types can be encouraged to occur at a predetermined growth stage of the plant.

It should be understood that the area between cells 332 may be relatively flat (as shown in FIGS. 3A and 3B) or may be shaped to direct water into or out of a cell 332. As discussed above, water may pool on top of the bed seed holder 330. As water is consumed by plants, the crown surface 338 of the bed seed holder 330 may be shaped to direct the last remaining water into or out of certain cells 332. In some embodiments, the crown surface 338 of the bed seed holder 330 may exhibit a concave shape, as depicted in FIG. 3C, such that water is directed inward toward the center of the bed seed holder 330. In some embodiments, the crown surface 338 of the bed seed holder 330 may exhibit a convex shape, as depicted in FIG. 3D, such that water is directed outward from the center of the bed seed holder 330.

Referring again to FIG. 3B, a bed seed holder 330 may include a spigot 336 that is selectable to control the release of water from the cells 332. The spigot 336 may be in fluid communication with all or a portion of the cells 332, such that water may be drawn from may be disposed on the flange to prevent water from pooling too deeply. In some embodiments, the spigot 336 may be in electronic communication with a computing device (as will be described below) that controls selective opening of the spigot 336.

The spigot 336 may be controlled to manage the level of water in the cell 332 throughout the growth cycle of the plant type For example, in some plant types, the presence of too much water when the plant is a seed or a seedling may lead to adverse pressures on the plant. Therefore, during these portions of the growth cycle, the spigots 336 may be controlled to allow water to be drained away from the seed or seedling, thereby preventing water from pooling around the seed or seedling. In contrast, as the seedling progresses in maturity, the plant may benefit from higher quantities of water being present. During these portions of the growth cycle, the spigots 336 may be controlled to allow water to be maintained in the cells 332 to enhance growth of the plant. In some embodiments, the spigot 336 may be an electronically controlled valve, for example, a solenoid valve, that selectively opens or closes, thereby allowing water to exit the cells 332 that are in fluid communication with the electronically controlled valve.

In various embodiments, the spigot 336 may control the rate of water removal from the cell 332. In some embodiments, the spigot 336 may be selected to have a high rate of water removal from the cell 332 at times corresponding to periods of the plant's growth cycle in which excess water is undesired and may be selected to have a low rate of water removal from the cell at time corresponding to periods of the plant's growth cycle in which additional water is desired. In such an embodiment, the spigot 336 may include an adjustable nozzle that increases in size to allow for an increased flow rate of water and decreases in size to allow for a decreased flow rate of water.

In some embodiments, the spigot 336 may be placed in fluid communication with the bed seed holder 330, such that all non-absorbed water may be drained from the bed seed holder 330. In some embodiments, the spigot 336 may be placed in fluid communication with the each of the cells 332 of the bed seed holder 330, such that all non-absorbed water may be drained from the cells 332. In some embodiments, the bed seed holder 330 may include a wicking media (not shown) that extends into each of the cells 332 of the bed seed holder 330, and allows water to flow into the cells 332 or out of the cells 332 based on the position of the wicking media and the relative moisture levels at positions along the wicking media.

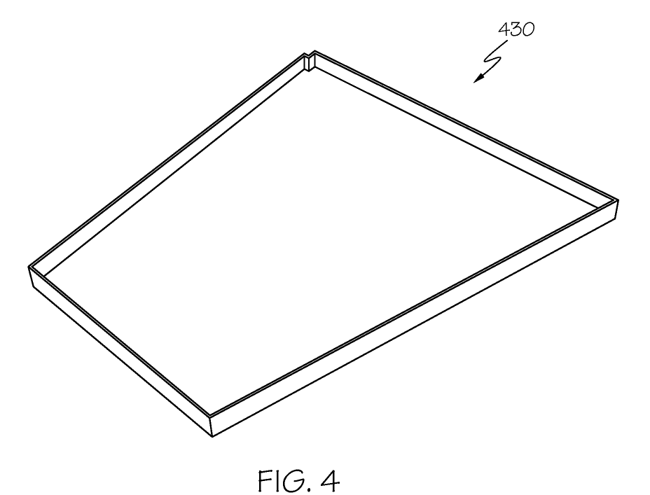

FIG. 4 depicts a bed seed holder 430 having a generally trapezoidal shape according to some embodiments described herein. As illustrated, the bed seed holder 430 may be selected to have a shape that more effectively utilizes the shape of the industrial cart 104 and/or tray 220 (as depicted in FIG. 2). Additionally, while some embodiments of the bed seed holder 430 may include a single cell for receiving seeds, the bed seed holder 430 may include a plurality of cells, depending on the embodiment.

FIG. 5 depicts a side view of a bed seed holder 530 with a flange 534 and a spigot 536, according to embodiments described herein. As illustrated, the bed seed holder 530 may include a plurality of cells 532 that extend from a crown surface 538 (depicted with dashed lines to indicate that the plurality of cells 532 and the crown surface 538 would not be visible from this perspective). Also depicted is a flange 534, which allows water to pool outside of the cells 532 and above the crown surface 538. The flange 534 is also positioned to maintain a desired water level in the bed seed holder 530. A distance between the crown surface 538 and the flange 534 defines an elevation envelope 540. Because the flange 534 extends to a height greater than the spigot 536, the flange 534 may generally maintain the level of the water above the crown surface 538, including when water sloshes across the bed seed holder 530, for example, due to movement of the bed seed holder 530 along the assembly line grow pod.

As discussed above, the spigot 536 may be positioned at a vertical height above the cells 532 and/or may be positioned at a vertical height below the bottom of the cells (as shown in FIG. 3B). The spigot 536 may be selectable and controllable in some embodiments to maintain a desired water level in the bed seed holder 530 and/or in each of the cells 532. As an example, some embodiments may be configured to close or partially close a spigot 536 in response to a desired to maintain a higher water level. When the water is to be drained, the spigot 536 (which may extend down to the cells 532 in this embodiment) may open to allow the water to drain. Similarly, some embodiments may be configured such that one or more of the cells 532 includes a spigot for draining water from individual cells. The spigot 536 maintains the level of the water at a vertical height that is less than the elevation envelope 540.

The bed seed holder 530 may include a water level sensor 514 that determines the level of the water in at least one of the cells 532, as described below. The water level sensor 514 forms part of the watering component, and is used in evaluating the water that is present in the sampled cell 532. Examples of such water level sensors including, for example and without limitation, a float switch, a magnetic switch, an RF switch, a thermal dispersion sensor, a magnetic level gauge, a magnetorestrictive gauge, an RF transmitter, a radar sensor, or an ultrasonic sensor. The water level sensor 114 may be in electronic communication with a computing device, as described below, which monitors the level of water in the bed seed holder 530, and initiates distribution of additional water from the watering component or release of water from the selectable spigot 536.

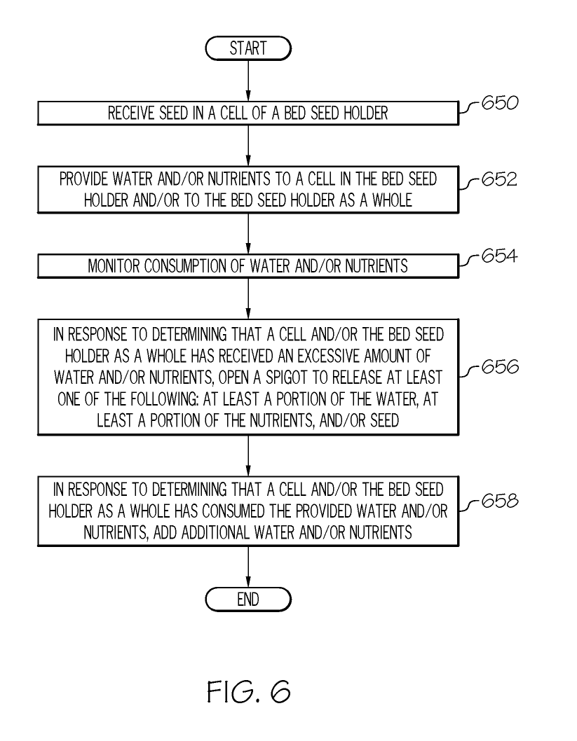

FIG. 6 depicts a flowchart for providing a bed seed holder 230, according to embodiments described herein. As illustrated in block 650, a seed may be received in a cell of a bed seed holder 230. In block 652, water and/or nutrients may be provided to the cell in a bed seed holder 230 and/or to the bed seed holder 230 as a whole. In block 654, consumption of the water and/or nutrients may be monitored. In block 656, in response to determining that a cell 332 and/or the bed seed holder 230 as a whole has received an excessive amount of water, a spigot 536 may be opened to release at least one of the following: at least a portion of the water, nutrients, and/or the seed. In block 658, in response to determining that the seed has consumed the provided water and/or nutrients, additional water and/or nutrients may be provided to the bed seed holder 230.

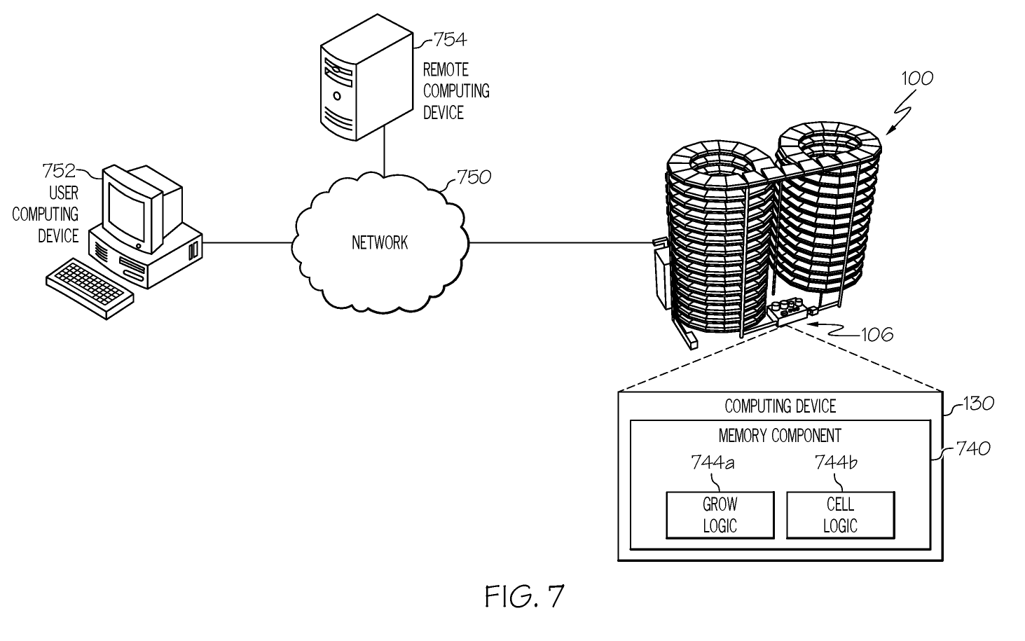

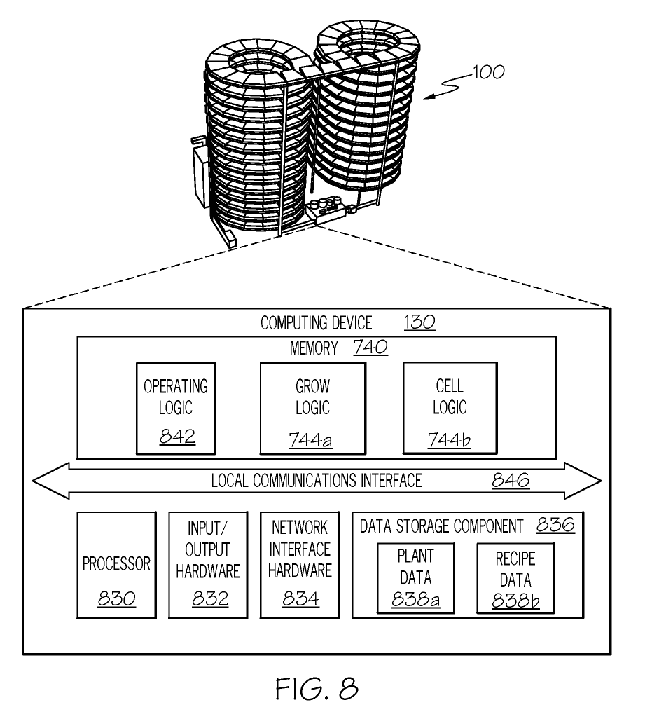

FIG. 7 depicts a computing environment for providing a bed seed holder 332, according to embodiments described herein. The computing device 130 may include a memory component 740, which stores grow logic 744a and cell logic 744b. The grow logic 744a may monitor a condition of a plant and/or seed, as well as implement one or more recipes for providing sustenance to the plant and/or seed. The cell logic 744b may be configured to determine the sustenance (such as water, nutrients, etc.) that the cell 332 and/or tray 220 has received and/or currently stores and may be configured to open and/or close a spigot 536 on the flange 534 and/or on one or more of the cells 332. In some embodiments, the grow logic 744a and the cell logic 744b may be programmed such that the conditions follow the predetermined recipe. In some embodiments, the grow logic 744a and/or the cell logic 744b may include a predictive logic that evaluates sampled data, for example, data relating to water level in the cells of the bed seed holder over time, and develops a prediction for other bed seed holders based on the data gathered from the sampled bed seed holder. For example, if data indicates that water is not evaporating or being consumed as quickly as the recipe indicates, the grow logic 744a and/or the cell logic 744b may be modified to reduce the delivery of water from the watering component to the bed seed holders. Therefore, the grow logic 744a and the cell logic 744b may be updated to include a prediction of conditions that may reduce the consumption of water and/or nutrients of the assembly line grow pod 100.

Additionally, the assembly line grow pod 100 is coupled to a network 750. The network 750 may include the internet or other wide area network, a local network, such as a local area network, a near field network, such as Bluetooth or a near field communication (NFC) network. The network 750 is also coupled to a user computing device 752 and/or a remote computing device 754. The user computing device 752 may include a personal computer, laptop, mobile device, tablet, server, etc. and may be utilized as an interface with a user. As an example, a user may send a recipe to the computing device 130 for implementation by the assembly line grow pod 100. Another example may include the assembly line grow pod 100 sending notifications to a user of the user computing device 752.

Similarly, the remote computing device 754 may include a server, personal computer, tablet, mobile device, etc. and may be utilized for machine to machine communications. As an example, if the assembly line grow pod 100 determines a type of seed being used (and/or other information, such as ambient conditions), the computing device 130 may communicate with the remote computing device 754 to retrieve a previously stored recipe for those conditions. As such, some embodiments may utilize an application program interface (API) to facilitate this or other computer-to-computer communications.

FIG. 8 depicts a computing device 130 for providing a bed seed holder 330, according to embodiments described herein. As illustrated, the computing device 130 includes a processor 830, input/output hardware 832, the network interface hardware 834, a data storage component 836 (which stores systems data 838a, plant data 838b, and/or other data), and the memory component 740. The memory component 740 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable media. Depending on the particular embodiment, these non-transitory computer-readable media may reside within the computing device 130 and/or external to the computing device 130.

The memory component 740 may store operating logic 842, the grow logic 744a, and the cell logic 744b. The grow logic 744a and the cell logic 744b may each include a plurality of different pieces of logic, each of which may be embodied as a computer program, firmware, and/or hardware, as an example. A local interface 846 is also included in FIG. 8 and may be implemented as a bus or other communication interface to facilitate communication among the components of the computing device 130.

The processor 830 may include any processing component operable to receive and execute computer readable instructions (such as from a data storage component 836 and/or the memory component 740). The input/output hardware 832 may include and/or be configured to interface with microphones, speakers, a display, and/or other hardware.

The network interface hardware 834 may include and/or be configured for communicating with any wired or wireless networking hardware, including an antenna, a modem, LAN port, wireless fidelity (Wi-Fi) card, WiMax card, ZigBee card, Bluetooth chip, USB card, mobile communications hardware, and/or other hardware for communicating with other networks and/or devices. From this connection, communication may be facilitated between the computing device 130 and other computing devices, such as the user computing device 752 and/or remote computing device 754.

The operating logic 842 may include an operating system and/or other software for managing components of the computing device 130. As also discussed above, grow logic 744a and the cell logic 744h may reside in the memory component 740 and may be configured to perform the functionality, as described herein.

It should be understood that while the components in FIG. 8 are illustrated as residing within the computing device 130, this is merely an example. In some embodiments, one or more of the components may reside external to the computing device 130. It should also be understood that, while the computing device 130 is illustrated as a single device, this is also merely an example. In some embodiments, the grow logic 744a and the cell logic 744b may reside on different computing devices. As an example, one or more of the functionalities and/or components described herein may be provided by the user computing device 752 and/or remote computing device 754.

Additionally, while the computing device 130 is illustrated with the grow logic 744a and the cell logic 744h as separate logical components, this is also an example. In some embodiments, a single piece of logic (and/or or several linked modules) may cause the computing device 130 to provide the described functionality.

As illustrated above, various embodiments systems and methods for providing a bed seed holder are disclosed. These embodiments may be configured to provide care of individual seeds, with the ability to monitor and control a water level on a tray and/or in a particular cell.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein include systems, methods, and non-transitory computer-readable mediums for providing a bed seed holder. It should also be understood that these embodiments are merely exemplary and are not intended to limit the scope of this disclosure.

1. A bed seed holder comprising:
a body having an elevation envelope;
at least one seed receptacle extending into the body, wherein the seed receptacle is adapted to maintain a fluid within the seed receptacle; and
a spigot that is adapted to maintain a level of the fluid within the body below the elevation envelope.

2. The bed seed holder of claim 1, wherein the spigot is positioned at a vertical height above the at least one seed receptacle.

3. The bed seed holder of claim 1, wherein the spigot is positioned at a vertical height below the at least one seed receptacle.

4. The bed seed holder of claim 3, wherein the spigot is in fluid communication with the at least one seed receptacle.

5. The bed seed holder of claim 1, wherein the spigot is selectively openable.

6. The bed seed holder of claim 5, wherein:
the bed seed holder comprises a plurality of spigots that are selectively openable; and
each of the spigots is in fluid communication with less than all of the seed receptacles of the bed seed holder.

7. The bed seed holder of claim 1, wherein the body comprises a crown surface and a plurality of cells that extend from the crown surface.

8. The bed seed holder of claim 7, wherein the crown surface comprises a concave shape.

9. The bed seed holder of claim 7, wherein the crown surface comprises a convex shape.

10. The bed seed holder of claim 1, further comprising a water level sensor that determines a level of water within the at least one seed receptacle.

11. An assembly line grow pod comprising:
a track;
a plurality of industrial carts adapted to translate along the track;
at least one bed seed holder positioned on the industrial carts, each of the bed seed holders comprising:
a body; and
at least one seed receptacle extending into the body, wherein the seed receptacle is adapted to maintain a fluid within the seed receptacle; and
a watering component that evaluates the water level within the at least one seed receptacle and selectively controls distribution of water to and from the bed seed holder to maintain to a pre-determined level.

12. The assembly line grow pod of claim 11, wherein the watering component comprises a water level sensor that evaluates a level of water in the at least one seed receptacle.

13. The assembly line grow pod of claim 12, further comprising a computing device comprising a processor and a computer readable instructions stored in a memory component that, when executed by the processor, causes the processor to:
evaluate the level of water in the at least one seed receptacle; and
selectively add water to the at least one bed seed holder until the water reaches a predetermined level.

14. The assembly line grow pod of claim 13, wherein the computer readable instructions further causes the processor to:
evaluate the level of water in the at least one seed receptacle at predetermined time intervals;
store data associated with the level of water in the at least one seed receptacle;
develop a prediction of the level of water in another of the at least one bed seed holders; and
selectively add water to the another of the at least one bed seed holders based on the prediction.

15. The assembly line grow pod of claim 14, wherein:
the bed seed holder further comprises a spigot; and
the computer readable instructions further causes the processor to selectively open the spigot to release water from the bed seed holder.

16. The assembly line grow pod of claim 13, wherein the computer readable instructions comprises a grow logic that monitors a condition of a seed and comprises at least one recipe for providing sustenance to the seed.

17. A method of growing a plant from a seed comprising:
delivering seed to at least one seed receptacle of a bed seed holder using a seeder component;
distributing water to the bed seed holder;
evaluating a level of water in the at least one seed receptacle with a water level sensor; and
distributing additional water to the bed seed holder to increase the level of water to a predetermined level.

18. The method of claim 17, wherein the evaluation of the level of water in the at least one seed receptacle is completed by a computing device comprising a processor and a computer readable instructions stored in a memory component that, when executed by the processor, causes the processor to evaluate the level of water in the at least one seed receptacle based on the water level sensor.

19. The method of claim 18, wherein:
the seed receptacle is adapted to maintain a fluid within the seed receptacle;
the bed seed holder further comprises a spigot; and
the computer readable instructions further causes the processor to selectively open the spigot to release water from the bed seed holder.

20. The method of claim 18, wherein the computer readable instructions further causes the processor to:
evaluate the level of water in the at least one seed receptacle at predetermined time intervals;
store data associated with the level of water in the at least one seed receptacle;
develop a prediction of the level of water in another of the at least one bed seed holders; and
selectively add water to the another of the at least one bed seed holders based on the prediction.
